(19) United States
(12) Patent Application Publication
(10) Pub. No.: US 2024/0369383 A1
(43) Pub. Date: Nov. 7, 2024

(54) PERPENDICULAR COIL INTERFERENCE

(71) Applicant: AZOTEQ HOLDINGS LIMITED, Nicosia (CY)

(72) Inventors: Frederick Johannes BRUWER, Paarl (ZA); Daniël Barend RADEMEYER, Paarl (ZA)

(21) Appl. No.: 18/648,833

(22) Filed: Apr. 29, 2024

(30) Foreign Application Priority Data
May 5, 2023 (ZA) 2023/04977

(51) Int. Cl. G01D 5/20

(52) U.S. Cl. CPC G01D 5/2053

(57) ABSTRACT

An inductive user interface mechanism for determining displacement by measuring change in inductance caused by an interfering member moving perpendicularly into the core of a coil formed in two parts with a gap between the two parts.

### CROSS-REFERENCE TO RELATED APPLICATION

The present application claims priority from South Africa applications ZA 2023/04977, filed May 5, 2023, the content of which is hereby incorporated by reference into this application.

### BACKGROUND OF THE INVENTION

A trigger mechanism typically makes use of an electromechanical (make or break) switch or a rheostat mechanism linked to a member which is actuable by a user.

Problems associated with the use of the rheostat mechanism include inertia from a contact, which does not always return completely to a zero point, and wear and tear over time of use—this affects accuracy of indication, whereas the electromechanical switch only conveys information about a single point in the trigger movement.

### SUMMARY OF THE INVENTION

The invention provides a contactless measurement solution of axis rotation or linear displacement with no inertia and no wear and tear related to the measurement mechanism.

Use is made of an inductive coil which lies perpendicular to the axis of interfering member movement wherein said inductive coil has a core, with evenly distributed magnetic flux in the core, comprising two parts with a gap between two parts of the inductive coil. An interfering member, responsive to rotation around an axle or to linear movement due to user actuation, moves perpendicularly to the length of the coil, to a greater or lesser extent into the gap between the two parts of the inductor coil, thereby interfering with magnetic fields inside the core of the inductor. The design of the interfering member is such that the change in inductance is related to the movement of a trigger or a mechanical structure under influence of the user.

Magnetic flux lines in the core of the inductive coil are evenly spread i.e. along the length of the core and through the gap between the two parts, as long as the two parts of the solenoid coil are not too far apart. The use of ferrite cores inside the inductor windings helps to concentrate the magnetic flux and assists to work well even in a wider gap. Consequently sideways movement (along the axis of the length of the coil) of the interfering member in the core has very little effect on the inductance of the coil. This is very important in terms of manufacturing tolerance and trigger movement. However movement of the interfering member which results in more or less of the core diameter being blocked has a substantial effect on the inductance. This is important for accurate measurements of movement perpendicular to the length of the inductor coil without undue mechanical accuracy requirements in terms of sideways movement.

The interfering member can be a metal e.g. copper or iron etc. that reduces the inductance as the member moves to block more of the core. If the interfering member is a ferrite or similar high permeability material then the inductance is increased. The change in the inductance may be linearly or non-linearly related to the angular rotation or linear displacement and, in case of a non-linear relationship, it is possible to correct mathematically for the non-linearity. It is also possible to correct by designing the interfering member specifically to yield a linear change in inductance related to the interfering member displacement into the magnetic field core, or the interfering member can be shaped to assure or effect a change of inductance over an extended length of movement.

The use of the invention is not restricted to a specific application. For example a trigger mechanism which is used in gaming can have an interfering member of the kind described attached to a moving part of a trigger operable by a user. As the trigger is pulled the interfering member cuts perpendicularly into the gap between the two parts of the coil and the degree of movement can be ascertained by measuring the resulting change in inductance of the coil. Similarly the trigger may be a part of a user interface for a power tool such as a drill and the trigger movement may be in a straight line or around an axis, but the movement under actuation pressure of the user results in the interfering member blocking more of the magnetic flux. In this way the change in inductance is related to the trigger movement.

It is possible to achieve better performance and signal to noise ratios using a more differentially configured embodiment in which current is forced in opposing directions through the two parts of the coil.

Another differential embodiment comprises two similar inductor coils with a single interfering member designed to have a differential effect in the change of inductance in the two inductor coils resulting from displacement. This method can assist with tracking environmental changes such as temperature. With the method and implementation of an interfering member that equally but inversely (i.e. in an opposite sense) affects two similar inductors, when moved through the gap between the two parts of the coils the signal strength is doubled. Furthermore if the inductance rises or falls equally in both inductors, or in only one inductor, then this change in inductance(s) is not due to a change in the interfering member position and this information can be used to measure a signal more accurately and securely. To use temperature as an example—if both inductors are measured with the same integrated circuit and ambient temperature change, there is a likelihood that the inductance measurement can change. But since the inductance measurement change will be the same in both inductors, this unwanted noise can be mathematically removed or cancelled.

### BRIEF DESCRIPTION OF THE DRAWINGS

The invention is further described by way of example with reference to the accompanying drawings in which:

FIG. 1a is an view of an inductor coil structured as two parts with a respective ferrite core in each part and an interfering member which is movable perpendicularly to the length of the coil, partly blocking the magnetic flux lines in a gap between the two coil parts,

FIG. 1b is similar to FIG. 1a, but shows air core type coils,

FIG. 2 shows designs for interfering members that will result in a change of inductance over a long travel, and a short travel,

FIG. 3 shows an interfering member attached to a structure that rotates with relation to an axis,

FIG. 4 shows a differential coil arrangement,

FIG. 5 shows a differential coil arrangement responsive to a short travel distance of an interfering member, and

FIG. 6 is similar to FIG. 5 but with a differential change over a long travel distance.

### DESCRIPTION OF THE INVENTION

The attached drawings are exemplary of the invention and are neither exhaustive nor complete. Other configurations which fall within the scope of the invention are possible.

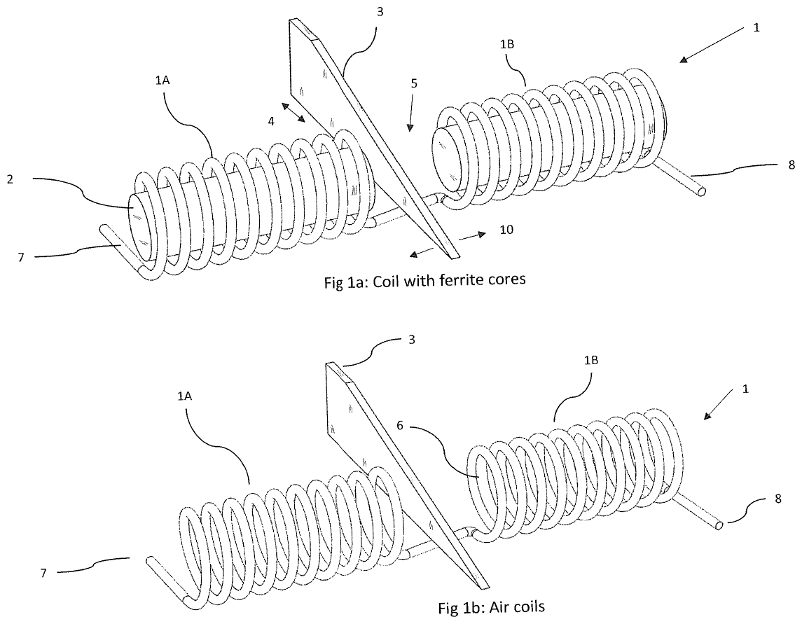

FIG. 1a shows an inductor coil 1 comprising two parts 1A and 1B with the two parts being separated by a gap 5 as per the drawing and each part of the coil has a respective ferrite core 2. The inductance of the inductor can be measured by connecting a conductive measurement unit to the inductor at circuit points 7 and 8. There is also an interfering member 3 movable in the direction of arrows 4 and, as it moves, to have a thicker side of the interfering member more inside the gap between the two coil parts, thereby blocking off more magnetic flux in the core of the coil and in the gap. If the interfering member is metal (copper, aluminium etc) then the more of the core it blocks, the lower the inductance measure between 7 and 8. If it is ferrite, the inductance will increase with more of the core diameter being filled.

In FIG. 1b the coil 1 has an air core 6.

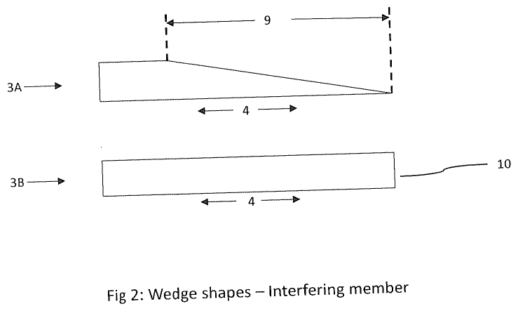

FIG. 2 shows an interfering member 3A, that induces a change of inductance over a relatively long travel distance 9, and an interfering member 3B that induces a more abrupt change of inductance over a shorter distance as a leading end 10 of the member 3B is flat.

In FIG. 1a the arrows 10 indicate a direction in line with the length of the inductive coil. Due to the even distribution of magnetic flux in the core and through the gap 5, movement of the interfering member in this direction 10 (sideways to the direction 4), has a negligible effect on the inductance. This is important for ease and cost of manufacturing.

The invention provides a contactless method of measuring the displacement of an interfering member moving perpendicularly through a gap in the coil i.e. perpendicularly to a longitudinal axis of a coil which comprise two parts separated by the gap.

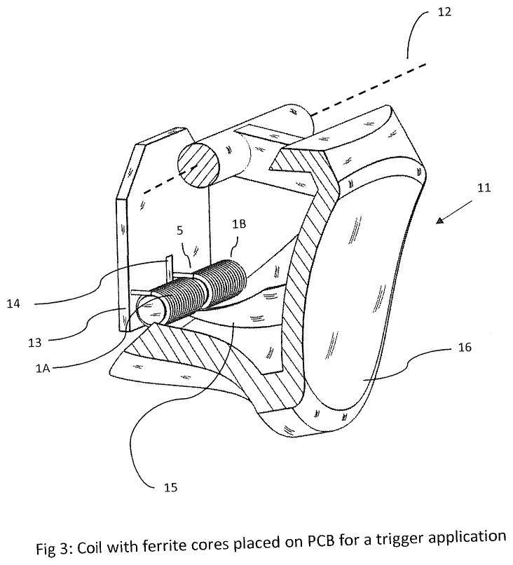

FIG. 3 relates to the use of the inventive concept comprising a contactless inductive trigger mechanism 11 for an apparatus that is constructed to move under actuation pressure of a user around an axis 12 to which a moving part is attached. This concept can be applied to a trigger mechanism of a gaming device or a power tool, wherein an interfering member 15 is attached to a moving part of a trigger 16 that moves into a gap 5 between the two parts 1A and 1B of the coil 1 which is supported by structure 13 and 14, and as the interfering member 15 penetrates the gap/core it affects the inductance of the coil.

Due to the moving part hinged around the axis 12, the motion of the interfering member is circular. This inductive coil construction which has two parts with a gap between, is simple to implement using “normal” straight coils with or without ferrite cores.

The inductive measurement can be used to set and monitor the key/trigger press activation depth, the depth of key/trigger travel, the speed of travel, user release characteristics, etc. This information can be conveyed to a controller of the apparatus and can be used to control operation.

The interfering member 15 can be shaped, e.g. curved with an increasing width, to produce a varying inductive measurement.

The key or trigger mechanism will typically include a spring or lever bias (not shown) to return the moving part to its position of no activation (a rest position) when the user releases pressure on the moving part.

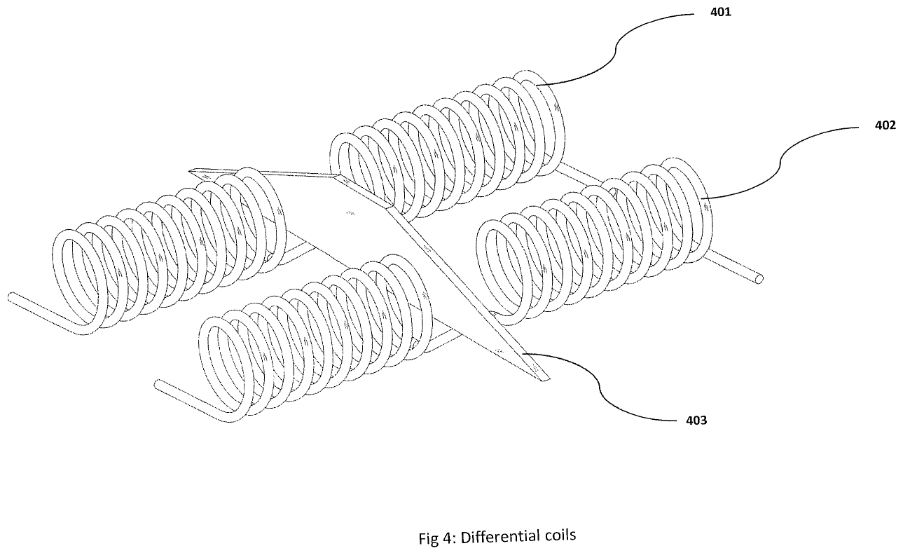

FIG. 4 illustrates the concept of two similar inductor coils (401, 402) with an interfering member 403 that has equal displacement in both inductor coils. The member 403 is shaped to have inverse or opposing effects of change on the inductances in the two inductor coils 401, 402 when moved in either direction perpendicularly to the length of the inductors i.e. one inductance will increase while the other inductance decreases—depending on the direction of movement of the member 403.

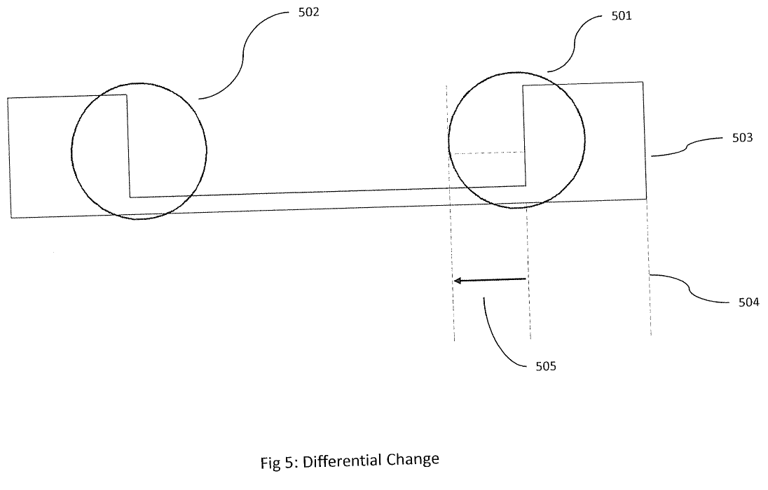

FIG. 5 shows an interfering member 503 which has abrupt changes in shape and which is movable transversely to two inductors 501, 502. The ideal (but not essential) construction is to have the interfering member 503 affecting both inductors 501. 502 equally in a resting position (see line 504). For example temperature drift is easier to track if the values of both measurements are similar or close to each other. In this example the distance of travel that will give a differential change in the two inductors 501, 502 is shown as 505. The embodiment is proposed to have the interfering member 503 affecting both inductors equally in terms of core area covered. If the interfering member 503 is moved from right to left then in this example the interfering member will gradually have less of an interfering effect on the inductor 502 whereas it will cover more area in the core of the inductor 501 and therefore have more of an interfering effect. This inverse effect will hold true until the interfering member has fully moved out of the inductor 502 and conversely the interfering member covers the inductor 501 to a maximum extent. That distance is shown as 505.

The interfering member can also be moved to the right to the position where the interfering member has fully left the core area of the inductor 501. From far left to far right is double the 505 distance. However it is advantageous to start from a base (a zero or resting) position where both inductors are the same i.e. exposed in the same way to the interfering member.

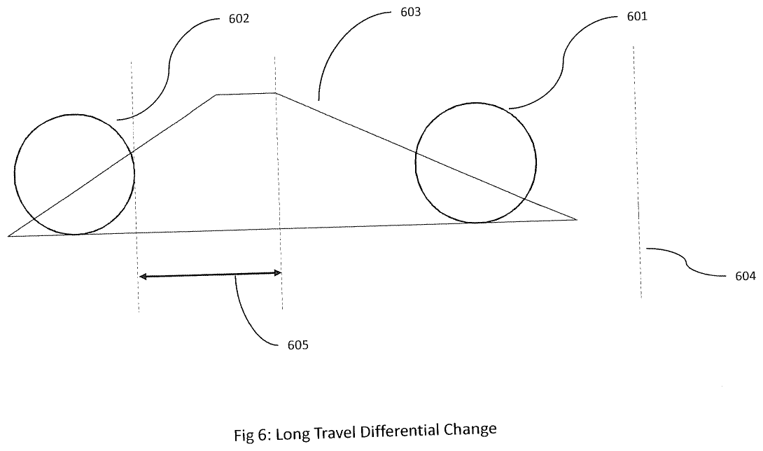

FIG. 6 shows an interfering member 603 which is tapered, of reducing width, in opposing directions to allow for longer travel with a continuous differential effect on two coils 601, 602. The interfering member is shown in a zero or resting position 604 with the objective of having approximately equal inductances measured in both inductors (although this is not essential). The distance of travel that yields a differential change in the two inductors is shown as 605. The movement from a zero position in this example will have a similar effect moving to the left or to the right.

Differential implementation makes it much easier to distinguish between a temperature shift and an actual user actuation. In general this differential implementation method helps to differentiate between noise (of any kind) and real signal information that must be recognized.

The differential implementation can also be applied to an interfering member linked with rotational movement as per the arrangement in FIG. 3.

1. An inductive based system for measuring movement, comprising measurement of the inductance of a coil inductor formed as two parts with a gap between the two coil parts, wherein the inductance of the inductor coil is changed by a magnetic flux interfering member moving perpendicularly through the gap between the two parts of the inductor coil, and wherein the change in measured inductance is related to the movement of the said interfering member.

2. The inductive system of claim 1 wherein the said interfering member is shaped to influence the travel distance over which the interfering member will cause a continuous change in the inductance.

3. The inductive system of claim 1 wherein movement of a trigger mechanism forming part of a user interface for an apparatus is directly related to the movement of the said interfering member.

4. The inductive system of claim 3 wherein said apparatus is a gaming console or a power tool.

5. The inductive system of claim 1 comprising another similar inductor coil and wherein the interfering member is designed to inversely change the inductances in the respective two inductors, as the interfering member is moved perpendicularly to the length of the inductors, in either direction.

6. A method of using inductive measurements to measure displacement of an object including the steps of providing an inductor coil with a gap in a length of the coil and moving a magnetic flux interfering member perpendicularly to the length of the coil and into the said gap in the inductor coil, and wherein the displacement to be measured is related to the movement of the interfering member and therefore to the change in inductance caused by the said interfering member movement.

7. The method in accordance with claim 6 including the step of shaping the interfering member in a way to gradually change the inductance over a longer movement distance.

8. The method in accordance with claim 7 including the step of linking the interfering member movement to a trigger mechanism that forms a part of a user interface.

9. The method in accordance with claim 6 including the steps of providing another and similar inductor coil and an interfering member designed and shaped to inversely affect the inductance of each coil when the interfering member is simultaneously moved through the gap in the respective inductor coils in a direction perpendicular to the lengths of the inductor coils.

10. The method in accordance with claim 9 including the steps of using the measured inductances from the two inductor coils to provide differential measurement information and of using the differential measurement information to improve accuracy of said measurement of displacement, and to improve signal strength and noise immunity.
